(19) United States
(12) Patent Application Publication
(10) Pub. No.: US 2013/0067645 A1
(43) Pub. Date: Mar. 21, 2013

(54) ADJUSTABLE SPORTS HELMET

(71) Applicants: Michael J. Musal, Van Nuys, CA (US); Gregory Dean, Van Nuys, CA (US); Chris Pietrzak, Van Nuys, CA (US)

(72) Inventors: Michael J. Musal, Van Nuys, CA (US); Gregory Dean, Van Nuys, CA (US); Chris Pietrzak, Van Nuys, CA (US)

(73) Assignee: Easton Sports, Inc., Van Nuys, CA (US)

(21) Appl. No.: 13/535,124

(22) Filed: Jun. 27, 2012

Related U.S. Application Data
(63) Continuation-in-part of application No. 13/235,186, filed on Sep. 16, 2011.

(51) Int. Cl. A63B 71/10; A42B 3/12; B23P 11/00; A42B 3/20

(52) U.S. Cl. 2/414; 2/417; 2/424; 29/426.1

(57) ABSTRACT

A protective sports helmet includes features that promote efficient fit adjustment and efficient donning and removal of the helmet. The helmet optionally includes a front shell portion pivotably connected to a rear shell portion to promote easy donning and removal of the helmet. Further, the upper region of the front shell optionally is longitudinally adjustable relative to the upper region of the rear shell. Cam mechanisms optionally are provided on the helmet shell for securing straps of a chin cup at desired lengths. The cam mechanisms optionally each include a self-energizing grip member that increasingly engages the strap when the strap is pulled taut while the cam mechanism is in the locked position. A face guard optionally is attached within the helmet shell structure, or within padding inside the shell, which provides a smooth helmet exterior and promotes distributed energy transfer from the face guard to the helmet shell.

### PRIORITY CLAIM

This application is a Continuation-in-Part of U.S. patent application Ser. No. 13/235,186, filed Sep. 16, 2011, and now pending.

### BACKGROUND

Existing protective sports helmets, such as helmets for lacrosse, hockey, football, and baseball, can be difficult to don, and it can be challenging for a user to make efficient fit adjustments, particularly during a game. For example, when a wearer pulls on a typical sports helmet, he or she has to pull the sides out laterally to fit the helmet over the wearer's ears. This often results in the fit not being ideally snug in a lateral direction. Further, a helmet that fits a given wearer well in the lateral direction may not fit well in a longitudinal direction. Adjusting or attaching the chin straps also can be difficult, particularly when the wearer does so while wearing lacrosse or hockey gloves.

Protective face masks, face cages, or face guards on existing sports helmets typically are attached to the exterior of the helmet shell via clips, straps, or loops. While the face guards are generally secured in place, they tend to move or slide slightly during play, and are not particularly adept at distributing energy from impacts.

### SUMMARY

A protective sports helmet, such as a lacrosse, hockey, football, or baseball helmet, includes one or more features that promote efficient fit adjustment and efficient donning and removal of the helmet. In one embodiment, the helmet includes a front shell portion hingedly or pivotably connected to a rear shell portion. The lower region of the front shell portion is pivotable away from the lower region of the rear shell portion to provide ear channels and to promote easy donning and removal of the helmet. The upper region of the front shell may additionally or alternatively be longitudinally adjustable relative to the upper region of the rear shell via a multi-position, longitudinal adjustment mechanism.

Cam mechanisms optionally are provided on the helmet shell for securing straps of a chin cup or chin guard assembly at desired lengths. The cam mechanisms optionally each include a self-energizing grip member that increasingly engages the strap when the strap is subjected to a load while the cam mechanism is in the locked position. A face guard optionally is attached within the helmet shell structure, or within padding inside the shell, which provides a smooth helmet exterior and promotes distributed energy transfer from the face guard to the helmet shell.

Other features and advantages will appear hereinafter. The features described above can be used separately or together, or in various combinations of one or more of them.

### BRIEF DESCRIPTION OF THE DRAWINGS

In the drawings, wherein the same reference number indicates the same element throughout the views:

FIG. 1 is a rear-perspective view of a sports helmet including a front shell portion pivotably attached to a rear shell portion, according to one embodiment.

FIG. 2 is a sectional view taken along line 2-2 in FIG. 1.

FIG. 3 is a sectional view taken along line 3-3 in FIG. 1.

FIG. 4 is a sectional view taken along line 4-4 in FIG. 1.

FIG. 5 is a partial interior view of the ear region of the helmet shown in FIG. 1 with the helmet in the open position.

FIG. 6 is a side view of the helmet shown in FIG. 1 in the closed position.

FIG. 7 is a side view of the helmet shown in FIG. 1 in the open position.

FIG. 8 is a partial perspective view of the helmet shown in FIG. 1 with the face guard attached.

FIG. 9 is a partial perspective view of the helmet section shown in FIG. 1 with the face guard detached.

FIG. 10 is a side-sectional view of the helmet shown in FIG. 1.

FIG. 11A is a side view of a cam mechanism, according to one embodiment, in an open position, with the base region of the cam mechanism shown as transparent to reveal details of the cam lever.

FIG. 11B is a side view of the cam mechanism shown in FIG. 11A in a locked position.

FIG. 11C is a side view of the cam mechanism shown in FIGS. 11A and 11B in a locked position with the grip member pivoted to further engage the strap under a loading condition.

FIG. 11D is a side view of the cam mechanism shown in FIGS. 11A-11C in a locked position with the grip member further pivoted to further engage the strap under an extreme loading condition.

FIG. 12A is an exploded view of the hinge mechanism shown in FIG. 10.

FIG. 12B is a perspective view of the hinge mechanism shown in FIG. 12A.

FIG. 13A is an exploded view of a longitudinal adjustment mechanism, according to one embodiment.

FIG. 13B is a perspective view of the longitudinal adjustment mechanism shown in FIG. 13A.

FIG. 13C is a side-sectional view of the longitudinal adjustment mechanism shown in FIGS. 13A and 13B.

FIG. 14 is a partial, top perspective view of the helmet shown in FIGS. 1-10 with a section of the rear shell portion cutaway to show the overlap of the rear and front shell portions.

FIG. 15 is a top perspective view of a helmet including the longitudinal adjustment mechanism shown in FIGS. 13A-13C, according to one embodiment.

FIG. 16 is a rear-perspective view of a sports helmet including a front shell portion pivotably attached to a rear shell portion, with a dial on the rear shell portion for moving the helmet between an unlocked position and a locked position.

FIGS. 17A-17D are diagrammatic views of the dial shown in FIG. 16 moving from the unlocked position to the locked position.

FIG. 18A is a side-sectional view of a helmet including a removable face guard secured in a channel in the front shell portion of the helmet.

FIG. 18B is a magnified, side-sectional view of the face guard engaging the channel shown in FIG. 18A.

FIG. 19A is a side-sectional view of the helmet shown in FIGS. 18A and 18B illustrating the face guard being removed from the channel.

FIG. 19B is a magnified, side-sectional view of the face guard being removed from the channel shown in FIG. 19A.

FIG. 20 is a side-perspective view of the helmet shown in FIGS. 18-19 with the helmet inverted to illustrate the face guard secured in the channel.

FIG. 21A is a rear-perspective view of a sports helmet including a front shell portion pivotably attached to a rear shell portion, with an “over center” lever mechanism on the rear shell portion in a locked position.

FIG. 21B is a rear-perspective view of the sports helmet shown in FIG. 21A, with the “over center” lever mechanism in an unlocked position.

FIG. 22 is a partial perspective view of the receiving element of the “over center” lever mechanism shown in FIGS. 21A and 21B.

### DETAILED DESCRIPTION OF THE DRAWINGS

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail so as to avoid unnecessarily obscuring the relevant description of the various embodiments.

The terminology used in the description and claims presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list. Further, as used herein, terms such as “attached to” or “connected to” are intended to apply to situations in which two elements or portions of a structure or mechanism are integral with each other, as well, unless the context dictates otherwise.

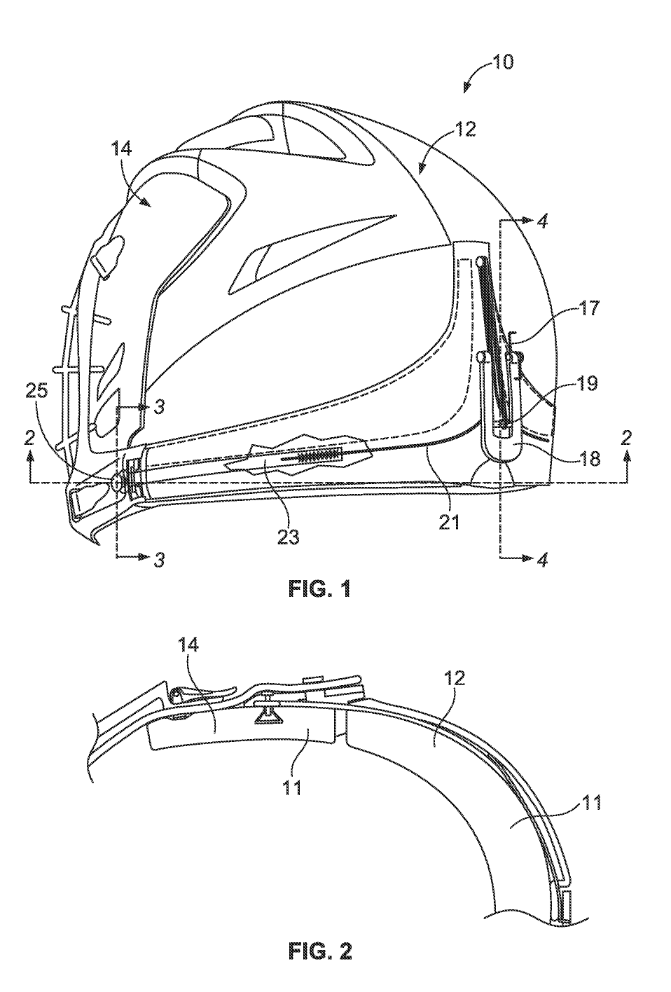

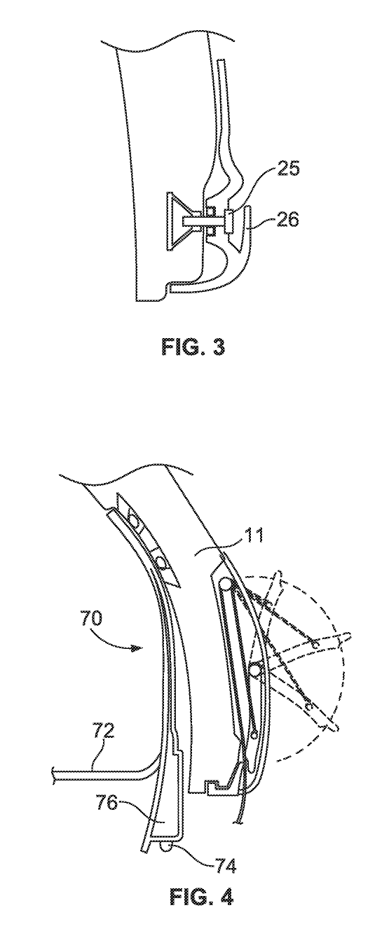

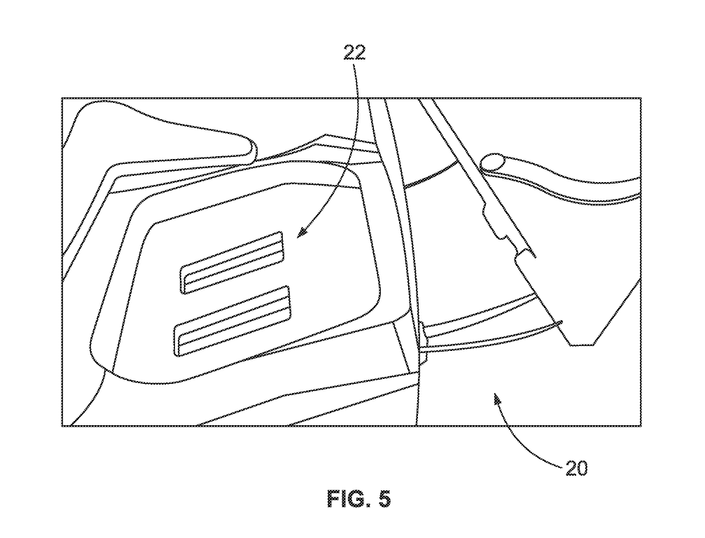

Turning now in detail to the drawings, as shown in FIGS. 1-10, a sports helmet 10, such as a lacrosse, hockey, football, or baseball helmet, includes a rear shell portion 12 and a front shell portion 14. The front and rear shell portions 14, 12 may be made of a polymer material, a composite material, or of another suitable material.

An upper region of the rear shell portion 12 is connected to an upper region of the front shell portion 14 via a hinge 13 (shown in FIG. 10), such as a mechanical hinge or living hinge, or via another connecting mechanism that provides pivoting movement between the front and rear shell portions. In this manner, the front and rear shell portions 14, 12 are rotatable between a closed, use position, and an open position that promotes efficient donning and removing of the helmet 10.

In one embodiment, the hinge 13 includes a male portion 15 attached directly or indirectly to, or integral with, one of the front and rear shell portions 14, 12, and a female portion 16 attached directly or indirectly to, or integral with, the other of the front and rear shell portions 14, 12. In the illustrated embodiment, a male portion 15 including a locking tab 29 and a living hinge region 27 is attached to the rear shell portion 12. A female portion 16 including an opening 31 that receives the locking tab 29 is attached to the front shell portion 14. The hinge portions 15, 16 may be attached via screws, bolts, adhesive, as part of the molding process, or via any other suitable mechanism or process.

One or more sections or a system of energy-attenuating material 11, such as expanded polypropylene (“EPP”) foam or another shock-absorbing material, are adhered or otherwise affixed to the inner surfaces of the front and rear shell portions 14, 12. The energy-attenuating material 11 alternatively may be in-molded with the front and rear shell portions 14, 12. While the primary pad material in the helmet is made of energy-attenuating or shock-absorbing material, comfort padding may also be included, particularly in regions intended to engage sensitive areas of a wearer's face, such as the cheeks. Comfort padding also may be used to provide customized fit and enhanced fit stability. Multi-layer padding, including an outer layer of energy-attenuating material and an inner layer of comfort padding, may optionally be used in these sensitive areas.

Other energy management systems may alternatively or additionally be included in the helmet 10. For example, an inflated air bladder system may be used instead of a foam liner. As another example, a series of inwardly protruding structures that crush to absorb impact—then return to their original shapes—may be used. Further, a variety or combination of energy management systems may be employed in the helmet 10 to meet the needs of a given application. For example, in a baseball helmet, a crushable foam designed to absorb a single, high-velocity impact may be used, whereas a recovering energy foam designed to absorb multiple, lower-velocity impacts may be used in a lacrosse helmet.

A lever 18, dial, or similar locking device is attached to one of the rear shell portion 12 and the front shell portion 14. In the embodiment illustrated in FIGS. 1-7, a lever 18 is attached to the rear region of the rear shell portion 12. The lever 18 is movable between an unlocked position that allows the front and rear shells portions 14, 12 to be pivoted relative to each other between an open position and a closed position, and a locked position that secures the front and rear shells portions 14, 12 in a closed, use position. A torsion spring 17 or similar device may be attached to or integral with the lever 18 to bias the lever 18 toward the locked position.

The lever 18 optionally includes a cross-bar 19 or similar structure to which a cable 21, cord, belt, or other connecting element is attached. The cable 21 runs from the lever 18 into the helmet through an opening in the rear shell portion 12, and along each inner side of the helmet shell, optionally between the inner shell wall and an unaffixed portion of the internal, energy-attenuating material 11. In one embodiment, the cable 21 may be stitched or otherwise attached to a first end of a belt 23 that is secured at its other end to a screw 25 or other anchor element projecting into the front shell portion 14. Alternatively, the cable 21 may have a greater length and be attached directly to the screw 25 or other anchor element on the front shell portion 14.

When the lever 18 is in the closed position, it pulls the cable 21 taut such that the front and rear shell portions 14, 12 are held securely against each other in the closed, use position. When the lever 18 is moved into the unlocked position, the cable 21 loosens such that the front and rear shell portions 14, 12 may be separated from each other into the open position to allow for efficient donning of the helmet 10. Upper regions of the front and rear shell portions 14, 12 may be configured to engage each other when the helmet is moved into the open position to limit the degree to which the helmet may be opened in the longitudinal direction.

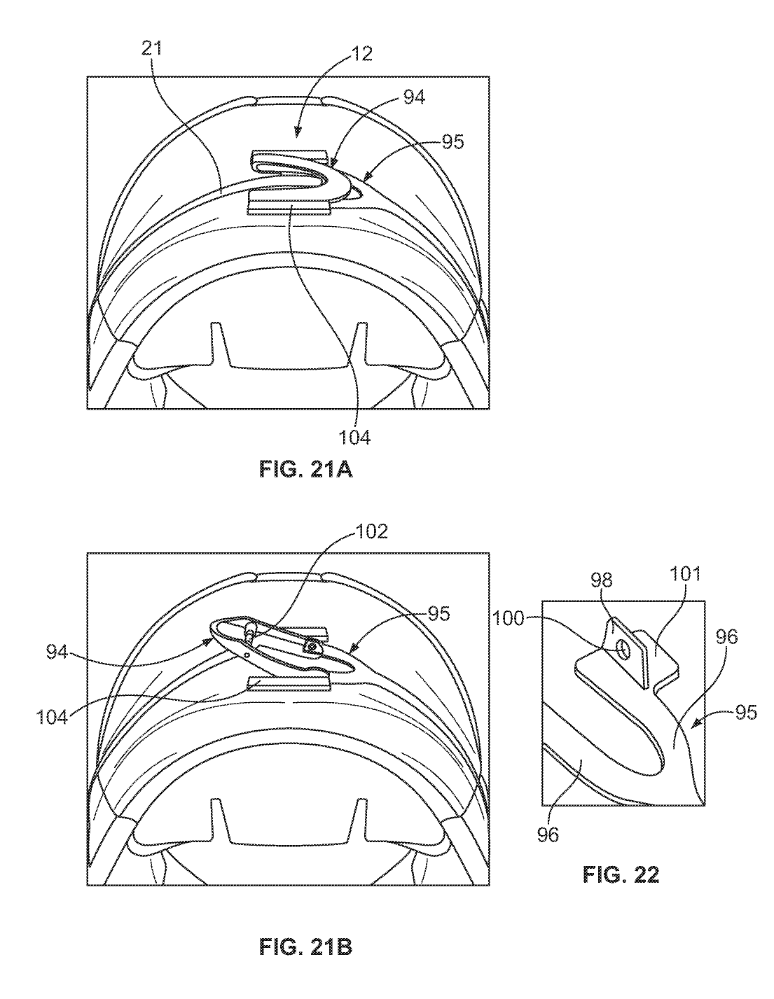

In another embodiment, as illustrated in FIGS. 21A, 21B, and 22, an “over-center” lever mechanism is included on the rear shell portion 12. The lever mechanism alternatively could be attached to the front shell portion 14. The lever mechanism includes a horizontally oriented lever 94 that is pivotably attached to a receiving element 95.

In the illustrated embodiment, the receiving element 95 includes two arms 96, each supporting an upwardly extending receiving member 98 with an opening 100 therein, to which the lever 94 is attached via pins, arms, or other connectors configured to engage the openings 100. In one embodiment, the arms 96 include tabs 101 or similar structures that are movable along channels or grooves provided in outwardly projecting portions 104 of the rear shell portion 12. Alternatively, the lever 94 could include the tabs or similar structures for moving along the channels or grooves. Any other suitable arrangement that allows the receiving element 95 and the lever 94 to move horizontally along the rear of the helmet could alternatively be used.

The lever 94 and the receiving element 95 are each connected to or integral with a cable 21, cord, belt, or other connecting element, which is connected to an interior or exterior of the front shell, either directly or via one or more additional cables, cords, or belts, as described above. The lever 94 is movable between an unlocked position (shown in FIG. 21B) that allows the front and rear shells portions 14, 12 to be pivoted relative to each other between an open position and a closed position, and a locked position (shown in FIG. 21A) in which the connecting elements are pulled taut to secure the front and rear shells portions 14, 12 together in a closed, use position. A torsion spring 102 or similar device may be attached to or integral with the lever 94 to bias the lever 94 toward the locked position.

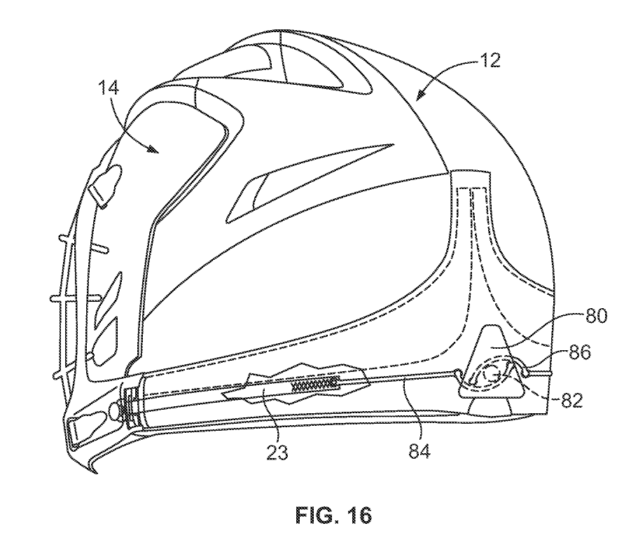

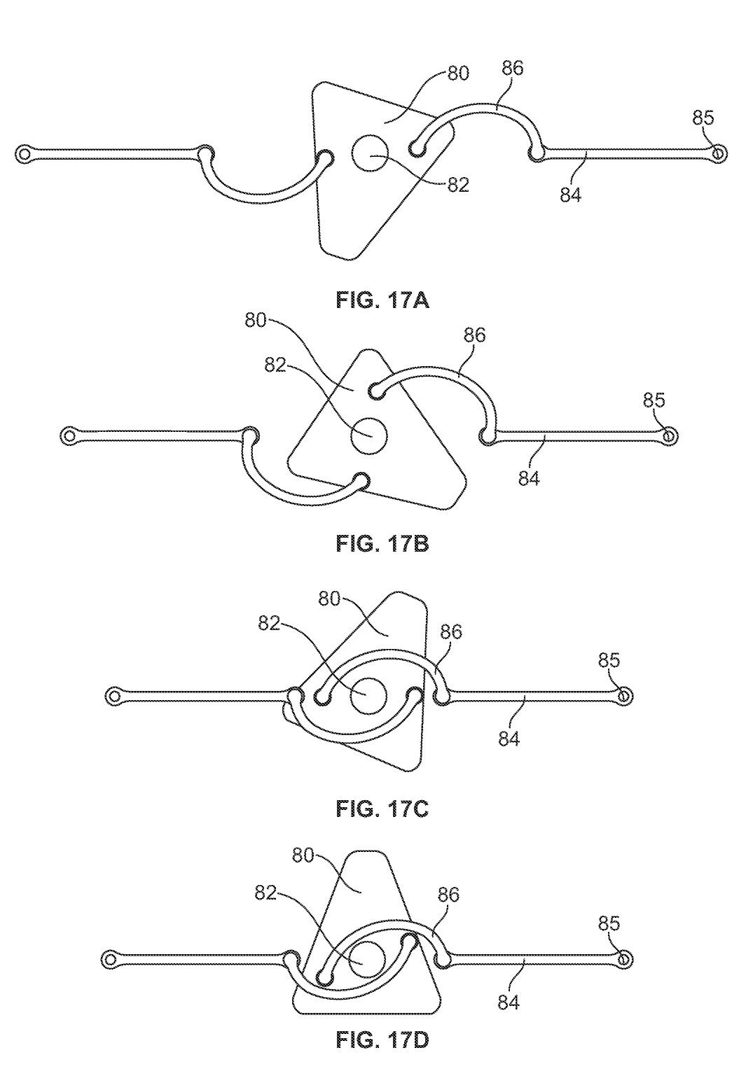

In yet another embodiment, as illustrated in FIGS. 16 and 17A-17D, a dial 80 is rotatably attached to the rear region of the rear shell portion 12. The dial 80 alternatively could be attached to the front shell portion 14. The illustrated dial 80 has a generally trapezoidal shape but it could have any other shape that facilitates rotation of the dial by a user. The dial 80 is rotatable about a cylindrical shaft 82 or post, or about another suitable structure or mechanism.

The dial 80 is attached to belts 84, cables, cords, or other connecting elements that are attached at their other ends to screws or other anchor elements projecting into the front shell portion 14, as described above. Openings 85 may be provided in the belts 84 to facilitate securement via screws or other anchor elements. As described above, a combination of cables and belts or other connecting elements may be used. The dial 80 may be directly connected to the belts 84 or may be connected to the belts 84 via intermediate linking elements 86. The linking elements 86 may be made of a metal material, a plastic material, or any other suitable material.

FIGS. 17A-17D illustrate multiple closure stages of the dial 80 as the dial 80 is rotated (counterclockwise in the drawings, which illustrate the dial 80 from the inside or “helmet-side” of the dial 80). FIG. 17A shows the dial when the helmet is in the fully open position with the front and rear shells separated from each other; FIG. 17B shows the dial when the helmet is approximately 50% closed; FIG. 17C shows the dial when the helmet is in its fully closed position; and FIG. 17D shows the dial in an “over-center” position in which the dial is locked into place (similar to the lever 18 in its closed position).

Further, as best shown in FIG. 14, the front and rear shell portions 14, 12 optionally overlap and engage each other to form one or more lap joints so that the shell portions cannot move laterally relative to each other. Additionally or alternatively, the front and rear shell portions 14, 12 may include corresponding tongues and grooves, or other cooperating engagements, to prevent the shell portions from moving laterally relative to each other. Accordingly, the overlapping shell structure absorbs the bulk of impact energy against the helmet 10, and the lever 18 need only be capable of locking the shell portions 12, 14 in place in the longitudinal direction.

In the open position, a channel 20 is formed on each inner side of the helmet 10. These inner channels 20 provide a pathway for the wearer's ears during donning and removal of the helmet 10. Thus, the wearer need not pull the sides of the helmet 10 laterally outward to move it past the wearer's ears. A recess 22 is provided on each interior side of the helmet to accommodate the wearer's ears in the closed, use position. Once the wearer's ears are located in the recesses 22, the helmet 10 may be pivoted to the closed position and locked into place by moving the lever 18 to the closed position. Because the helmet 10 does not need to be stretched laterally, it can provide a snug, stable, comfortable fit over, below, and about the wearer's ears.

In one embodiment, the helmet 10 includes a chin cup 30 or chin guard connected to the helmet shell via upper straps 32 and lowers straps 34. The straps 32, 34 may optionally be routed to the chin cup 30 inside the helmet 10, which improves stability and retention of the straps, as well as the aesthetic profile of the helmet 10. In one embodiment, the straps 32, 34 protrude to the exterior of the helmet 10 through openings 35 in the helmet shell.

Hinged cam levers 36 or similar securing devices are included near the openings 35 to secure the straps to the helmet shell at desired lengths. The cam levers 36 are rotatable into an open position to allow for adjustment of the strap lengths, after which the cam levers 36 may be rotated into the closed position to grip the straps 32, 34 and hold them in place. The cam levers 36 prevent or substantially prevent the straps 32, 34 from moving or loosening such that the straps need not be adjusted once they are secured at desired lengths.

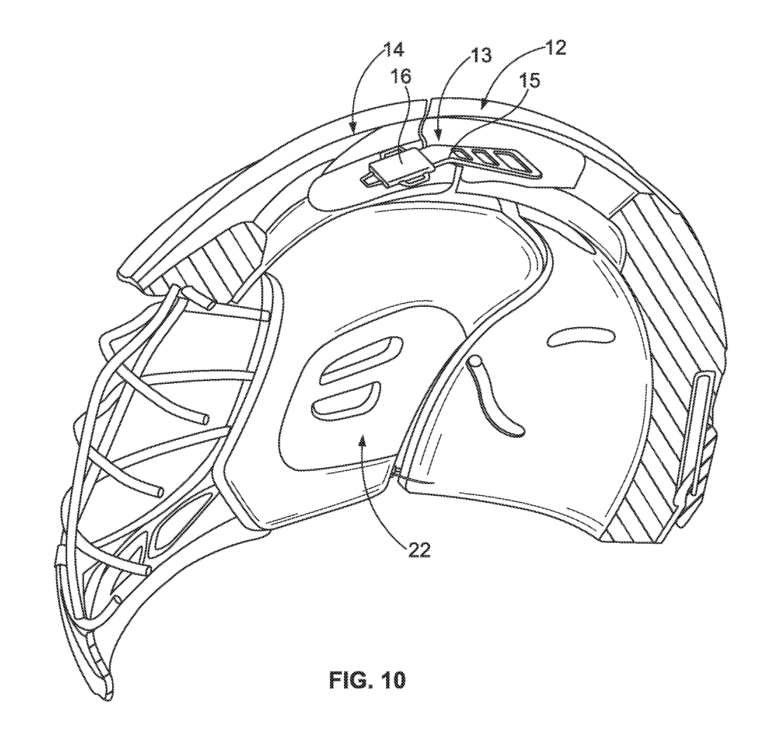

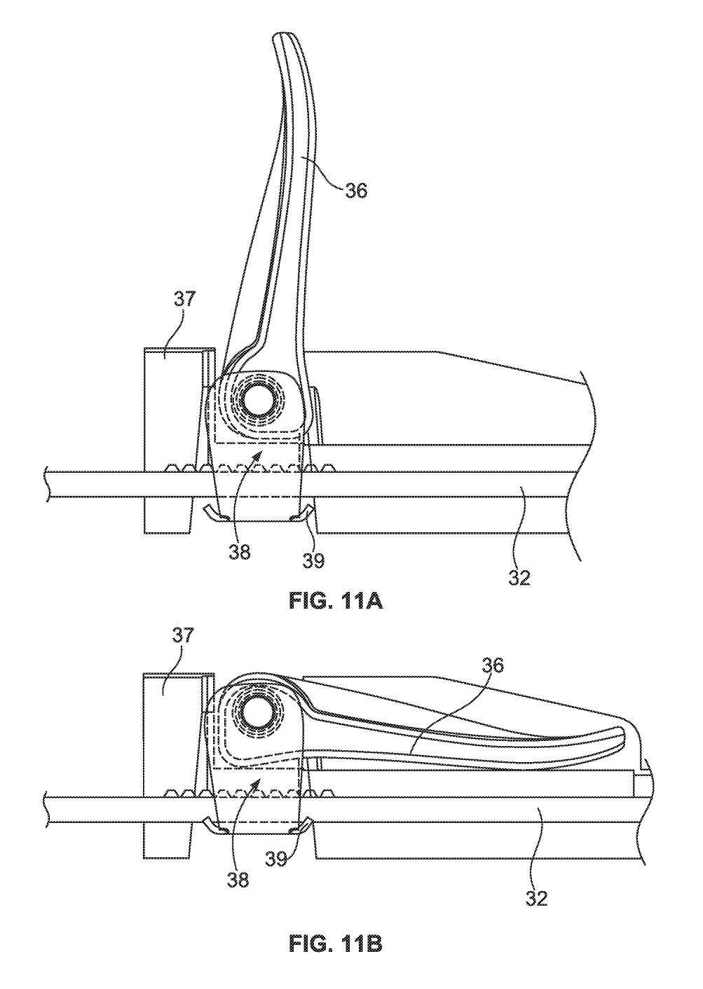

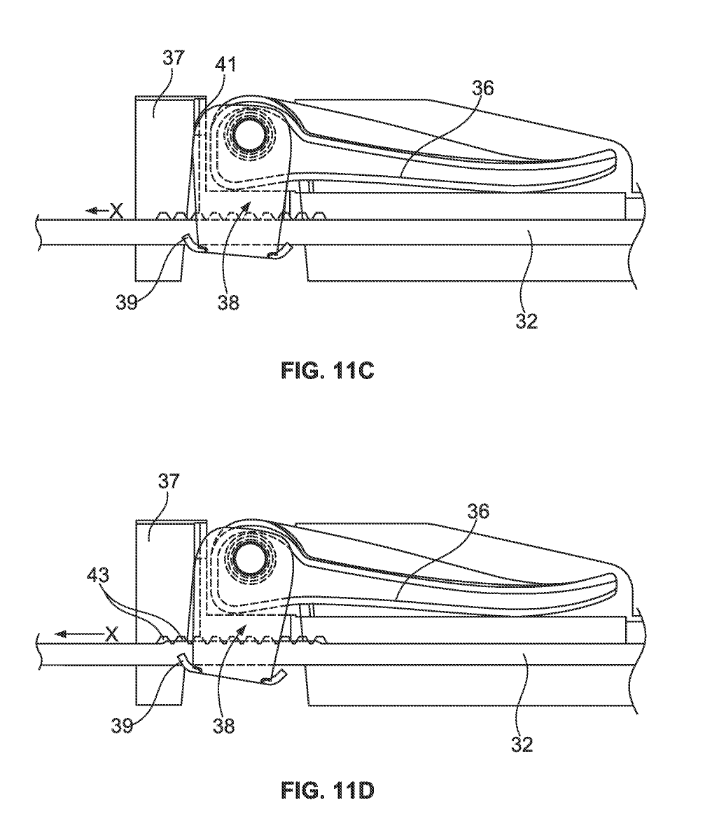

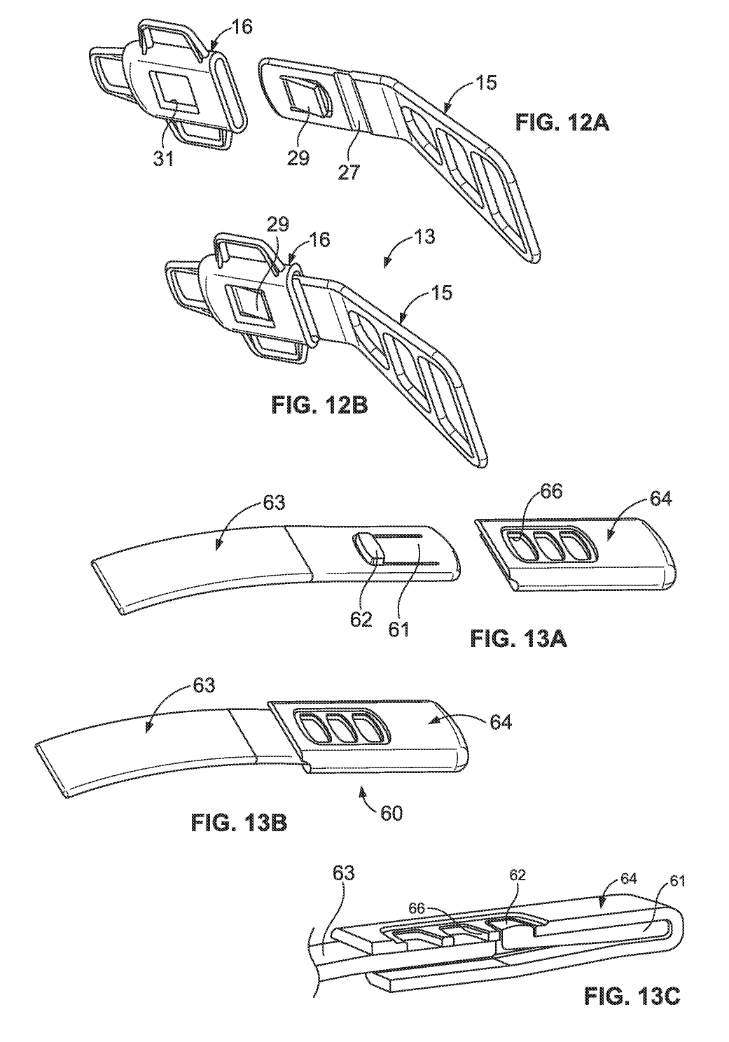

As shown in FIGS. 11A-11D, in one embodiment, each cam lever 36 is pivotably connected to a grip member 38 that may be pulled into engagement with an inner surface of the strap 32 (or 34) to secure the strap 32 in place. The grip member 38 optionally is in engagement with a base structure 37. When the cam lever 36 is pivoted from the open position (shown in FIG. 11A) to the closed position (shown in FIG. 11B), an engagement portion 39 of the grip member 38 is pulled into the strap 32 to secure the strap in place.

In one embodiment, when the strap 32 is pulled or subjected to a load in direction X (shown in FIG. 11C) while the cam lever 36 is in the locked position, the grip member pivots 38 about the cam lever 36—and about a fulcrum point 41 on the base structure 37—so that the engagement portion 39 further engages the strap 32 and more tightly secures it in place. In this manner, the cam mechanism is “self-energizing,” meaning that as the load applied to the strap 32 increases, the gripping force applied by the gripping member 38 also increases. Further, the cam mechanism can resist equivalent loads even if the thickness of the strap 32 is varied.

The base structure 37 optionally includes openings 43 or a receiving mechanism positioned adjacent to the outer surface of the strap 32. When an extreme load is applied to the strap in direction X (shown in FIG. 11D), the grip member 39 pivots to an even greater degree about the cam lever 36 and the fulcrum point 41 to more tightly engage the strap 32 and to force portions of the strap 32 into one or more of the openings 43. In this manner, the strap 32 is tightly secured, even under extreme loading conditions.

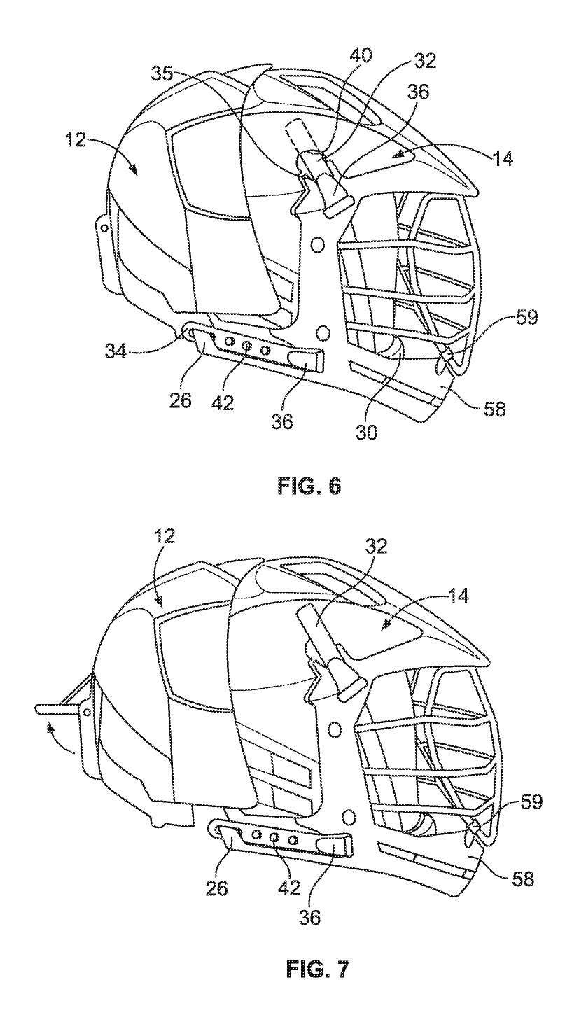

As shown in FIGS. 6 and 7, compartments 40 or protruding arms or tabs 26 optionally are included in or on the helmet shell for receiving the free ends of the straps 32, 34. In the illustrated embodiment, compartments 40 are included in the upper region of the front shell portion 14 for receiving the ends of the upper straps 32, and tabs 26 are included in the lower region of the front shell portion 14 for receiving the ends of the lower straps 34. Any other arrangement of compartments 40 or tabs 26 may alternatively be used. The compartments 40 or tabs 26 shield the free ends of the straps from contact with sticks, helmets, gloves, and so forth. Concealing the ends of the straps 32, 34 may also be aesthetically pleasing to many players, and it frees up additional helmet surface area (that otherwise would have been obscured by the strap ends) onto which team logos, jersey numbers, and so forth may be embellished.

The straps 32, 34 optionally include sizing indicators 42, such as printed numbers or raised bumps, to aid a user in adjusting the straps 32, 34 to desired lengths. For example, if a user adjusts the straps to a first length, then tries on the helmet and determines the straps 32, 34 need to be tightened or loosened, the sizing indicators 42 provide a guide for how much adjustment needs to be made. The sizing indicators 42 also provide an indication of whether the left and right straps are adjusted to the same length or to different lengths relative to each other.

Once desired strap adjustments are made by a user, the straps 32, 34 remain securely in place and do not need to be adjusted or re-connected each time a wearer dons the helmet. There is no need to unclamp or unsecure the straps between uses due to the shell arrangement that allows for donning and removing of the helmet 10 by pivoting the front and rear shell portions 14, 12 away from each other. This is particularly beneficial during a game, since a player will often be wearing bulky gloves that make it difficult to manipulate straps. With the hinged shell arrangement, only the lever 18 needs to be manipulated to allow for efficient removing and donning of the helmet 10.

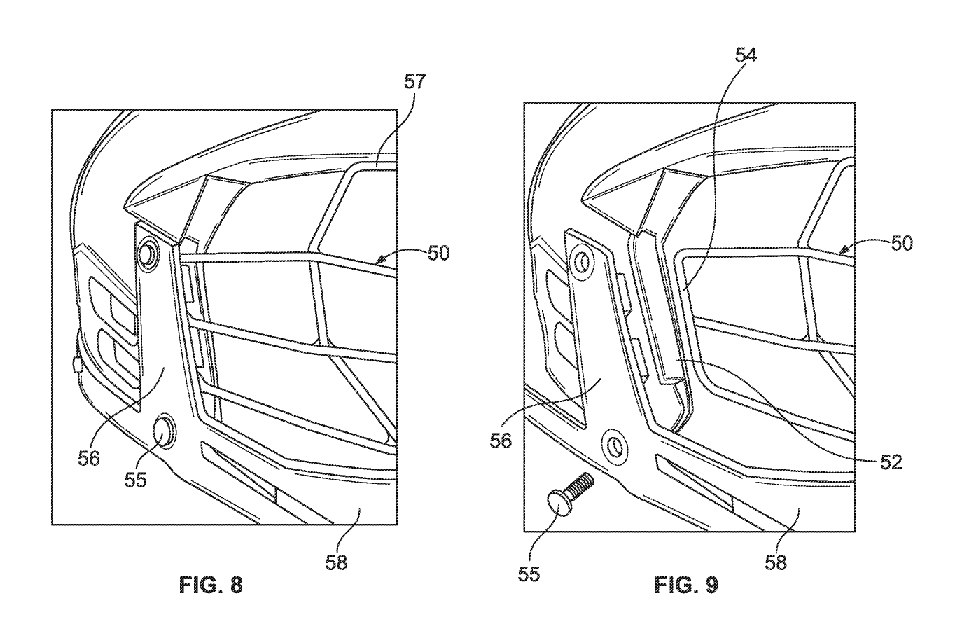

As shown in FIGS. 8 and 9, a face guard 50 optionally is attached to inset side regions of the front shell portion 14. The face guard 50 may be a cage, mask, or similar structure made from a metal, plastic, composite, or other suitable material. The front shell portion 14 includes an inset region 52 or channel on each of its sides for receiving a rearwardly extending section 54 of the face guard 50. A cover 56 is positioned over each of the rearwardly extending sections 54 and is attached to the front shell portion 14 via bolts 55, screws, or other suitable connecting devices. Such an arrangement facilitates efficient transfer of impact energy to the shell in a distributed loading pattern, as opposed to the point loading pattern that occurs in helmets in which the face guard is clipped to the helmet at multiple, discrete locations.

In one embodiment, the inset regions 52 may be lined with a cushioning element, such as an elastomeric adhesive or other cushioning material. Additionally or alternatively, the rearwardly extending section 54 of the face guard 50 may be coated or covered with a cushioning element. Providing such a cushioned interface between the face guard 50 and the helmet shell improves the damping characteristics of the helmet 10.

An upper section 57 of the face guard 50 may be secured in a channel 90, recess, or other opening under the visor region of the helmet such that it is contained within the helmet's profile. The channel 90 may be formed in the internal padding of the helmet or in the helmet shell itself. The channel 90 may contain a basket 91, a liner, or another structure for receiving the upper section 57 of the face guard 50. Alternatively, the upper section 57 of the face guard 50 may be attached to the front shell portion 14 via a clip or other connecting device, or in any other suitable manner.

The outer cover 56 may include an integral jaw protector 58, or may be connected to a separate jaw protector, that extends along the bottom of the face guard 50 to cover the sides of a wearer's jaw and the front of a wearer's chin. The face guard 50 optionally may be attached to the jaw protector 58 via clips 59, straps, or other connecting devices. The jaw protector 58 shields the wearer's jaw and chin from contact, and also provides a convenient structure for a wearer to grab onto and pull forward to move the helmet 10 into the open position when donning or removing the helmet.

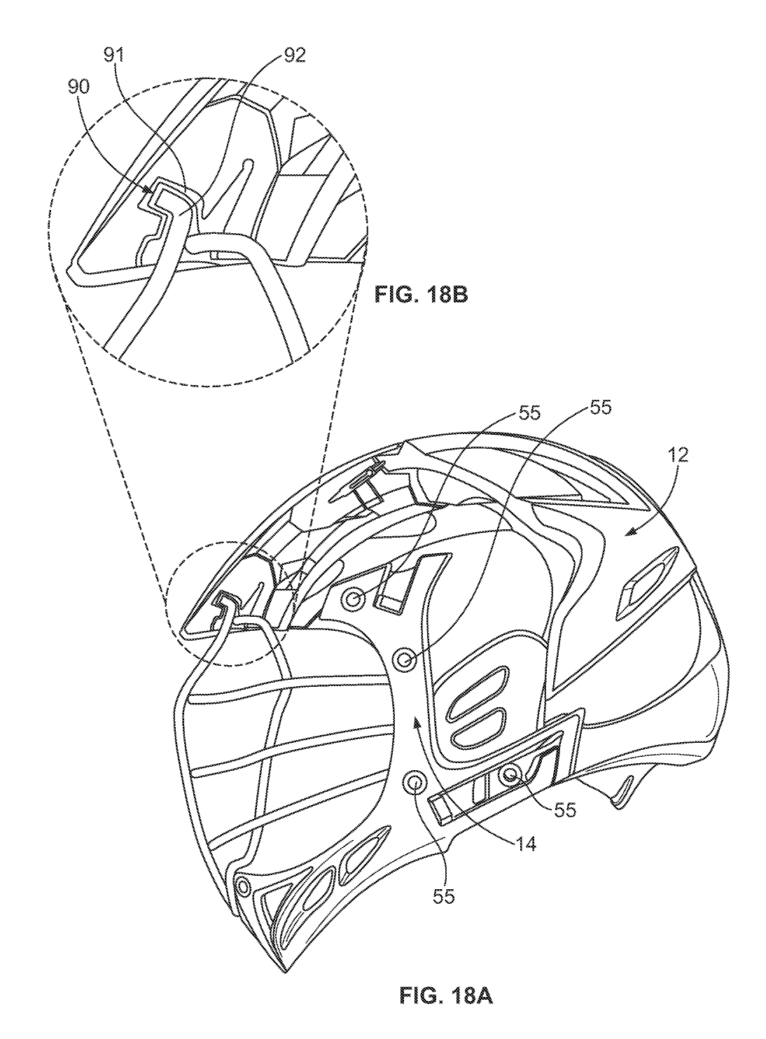

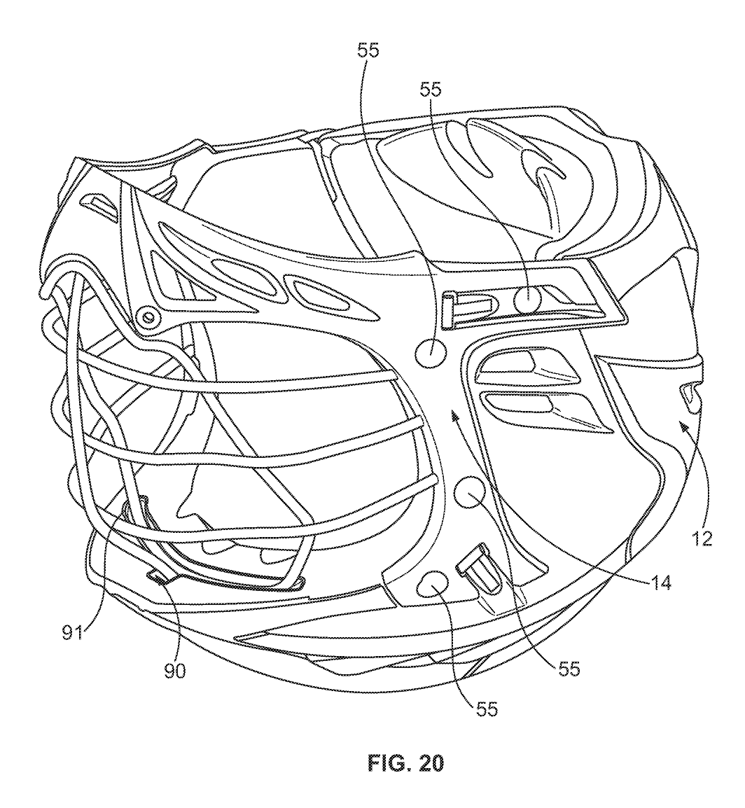

In the embodiment illustrated in FIGS. 18-21, the upper section 57 of the face guard 50 includes a bent, curved, or hooked portion 92 positioned in the basket 91 in the channel 90. This “hooked” arrangement tightly secures the upper section 57 to the front shell portion 14 so that the face guard 50 remains securely attached during the extreme impacts associated with contact sports. This arrangement also provides for easy assembly and rapid disassembly of the face guard 50 in the event of an on-field injury or other emergency.

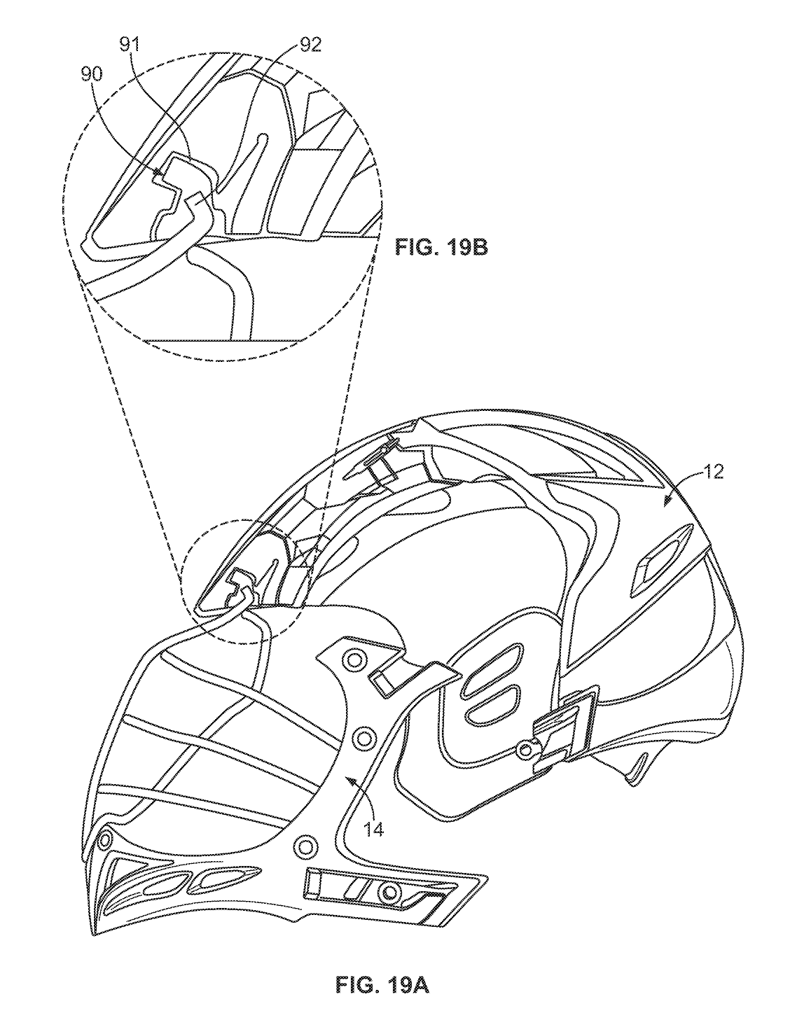

In one embodiment, the face guard 50 may be removed from the helmet by removing the bolts 55 that attach the outer covers 56 to the front shell portion 14. The rearmost portions of the outer covers 56 may then be pulled apart or slightly separated to provide freedom of movement of the covers 56. Next, the jaw protector 58 may be rotated forward and upward (away from the front shell portion 14) until the hooked portion 92 becomes disengaged from the channel 90, as shown in FIGS. 19A and 19B. At this point, the face guard 50 and cover assembly may be removed from the font shell portion 14. The face guard 50 may be re-attached by following these steps in reverse order.

In an alternative embodiment, the outer covers 56 may be omitted and the face guard 50 may be attached directly to the front shell portion 14. In this embodiment, once the bolts or other connectors used to secure the face guard 50 to the front shell portion 14 have been removed, the lower section of the face guard 50 may be rotated forward and upward (away from the front shell portion 14) until the hooked portion 92 becomes disengaged from the channel 90. At this point, the face guard 50 may be removed from the font shell portion 14.

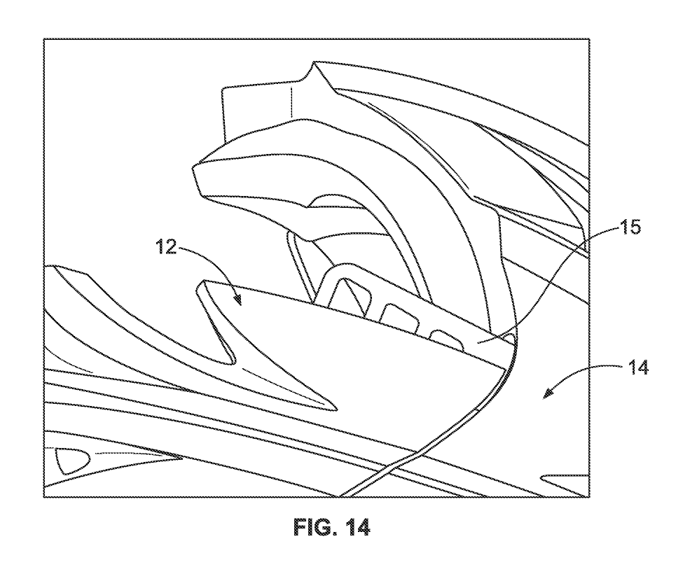

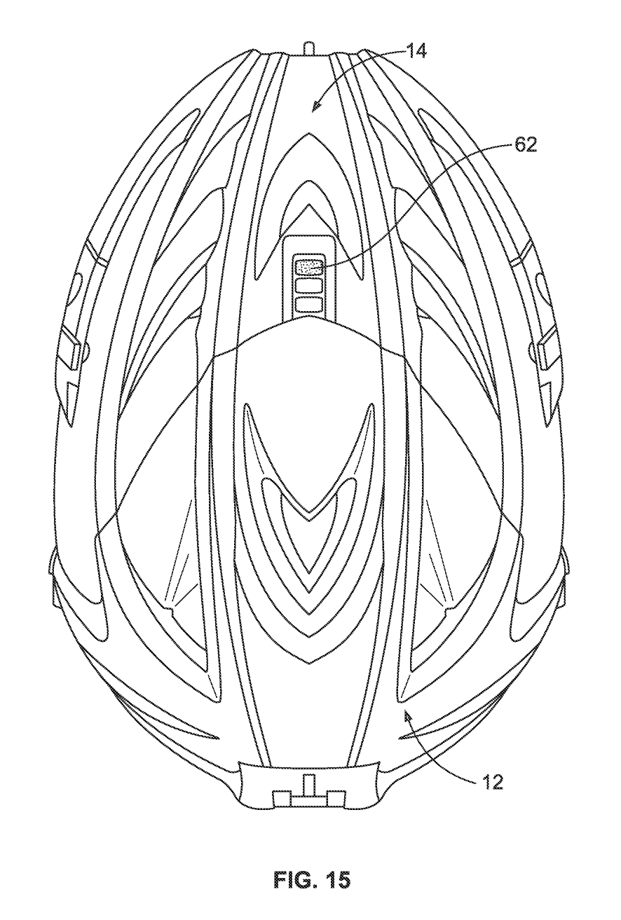

As shown in FIGS. 15 and 13A-13-C, the helmet 10 optionally includes an adjustment mechanism 60 at a crown region of the helmet 10 that provides for longitudinal adjustment between the front and rear shell portions 12, 14. The longitudinal adjustment mechanism 60 may be incorporated into the hinge structure or may be a separate element. In embodiments where ease of donning and removal is not required, a longitudinal adjustment mechanism 60 may be included while the hinge mechanism may be omitted.

In one embodiment, the adjustment mechanism 60 includes a spring-loaded or cantilevered arm 61 positioned on or integral with a band 63 or other support structure. The band 63 is directly or indirectly attached to or integral with an interior surface of one of the front and rear shell portions 14, 12. The arm 61 includes a button 62 or other activation element protruding to the exterior of the helmet shell from an end of the arm 61. A receiving component 64 attached to or integral with the other of the front and rear shell portions 14, 12 includes multiple openings 66 for receiving the button 62 (three openings 66 are shown in the illustrated embodiment but any other desired number of openings 66 may be included).

In another embodiment, the spring-loaded arm 61 may include one or more upward-facing grooves for receiving one or more downward projections on the receiving component 64, or may include one or more upward projections for engaging one or more downward-facing grooves on the receiving component 64. Any other suitable engagement mechanism that allows for relative longitudinal movement between the front and rear shell portions 12, 14 may be used.

When the button 62 is depressed, the front and rear shell portions 14, 12 may be moved longitudinally relative to each other between the provided positions. The button 62 may be released when it is aligned with the opening 66 that provides the desired helmet length for a given wearer, such that it moves upward into the opening 66 and locks the front and rear shell portions in place. Three alternate longitudinal positions are shown by way of example in the illustrated embodiment. Such an adjustment allows for a personalized, snug fit against a wearer's brow. Thus, a wearer may adjust the fit of the helmet against his or her brow, and may maintain the helmet in the desired fit position between uses.

The helmet 10 optionally includes an internal fit system, as well. Examples of such a fit system are described in U.S. patent application Ser. No. 12/191,000, filed on Aug. 13, 2008, which is incorporated herein by reference. In one embodiment, the helmet 10 includes a lateral and occipital adjustment system configured to engage the sides and back of a wearer's head and the nape of the wearer's neck. The lateral and occipital adjustment system may include one or more bands 72 (shown in FIG. 4) or straps attached or affixed to the energy-attenuating material 11 (or to the front shell portion 14) in the front interior region of the helmet 10, via screws, snaps, or any other suitable connectors. The bands may be made of a relatively flexible plastic, nylon, or other suitable material.

The bands 72 may be tightened or loosened, such that they are displaced laterally toward or away from the central interior of the helmet 10, via a dial 74, knob, or another device located at the rear interior of the helmet 10. An occipital pad 76 or similar element may be attached to the dial 74, the bands 72, or another region for engaging the rear of a wearer's head or the nape of the wearer's neck. Any other suitable lateral and occipital adjustment system may alternatively be used in the helmet 10.

To don the helmet 10, a user moves the lever 18 or rotates the dial 80 to the open position, then positions the rear padding of the helmet against the rear of the user's head. The user then pulls the face guard 50 or jaw protector 58 forward to pivot the front shell portion 14 away from the rear shell portion 12 into the open position. The user then pulls the face guard 50 or jaw protector 58 in a downward direction such that the channels 20 move past his or her ears until the ears are positioned in the recesses 22. The front shell portion 14 is then moved into the closed position, either automatically or with the aid of the user.

The chin cup 30, assuming the straps 32, 34 have been properly adjusted, engages the user's chin in the closed position. The user then moves the lever 18 or rotates the dial 80 into the locked position, which tightens the cables 21 or other connecting elements, thus securing the front shell portion 14 to the rear shell portion 12. To remove the helmet 10, the user simply moves the lever 18 or rotates the dial 80 to the open position, pulls the face guard 50 or jaw protector 58 forward, then lifts the helmet off of his or her head.

Any of the above-described embodiments may be used alone or in combination with one another. Further, the sports helmet may include additional features not described herein. While several embodiments have been shown and described, various changes and substitutions may of course be made, without departing from the spirit and scope of the invention. The invention, therefore, should not be limited, except by the following claims and their equivalents.

What is claimed is:

1. A sports helmet, comprising:
a shell including a first portion pivotably connected to a second portion;
a dial on an exterior of the second portion rotatable between a closed position and an open position;
a connecting element attached to the dial and to the first portion of the shell;
wherein when the dial is rotated into the closed position it holds the connecting element taut such that the first portion is in secure engagement with the second portion, and when the dial is rotated into the open position the connecting element is loose such that a lower region of the first portion may be moved away from a lower region of the second portion.

2. The sports helmet of claim 1 wherein the dial has a generally trapezoidal shape.

3. The sports helmet of claim 1 wherein the connecting element comprises a plurality of cables, wherein each cable is attached to the dial via a linking element.

4. The sports helmet of claim 1 wherein the first portion and the second portion are in overlapping engagement with each other such that they are movable only in a longitudinal direction relative to each other.

5. The sports helmet of claim 1 wherein the connecting element comprises a belt that passes from outside the second portion to inside the second portion.

6. The sports helmet of claim 1 wherein the connecting element is attached to an anchor element on an interior of the first portion of the shell.

7. The sports helmet of claim 1 wherein the connecting element is attached to the first portion of the shell via a belt.

8. A sports helmet, comprising:
a shell including a first portion pivotably connected to a second portion;
a receiving element positioned at an exterior of the second portion;
a lever pivotably attached to the receiving element, the lever pivotable between a closed position and an open position;
a first connecting element attached to the lever and to the first portion of the shell;
a second connecting element attached to the receiving element and to the first portion of the shell;
wherein when the lever is pivoted into the closed position, the first and second connecting elements are held taut such that the first portion is in secure engagement with the second portion, and when the lever is pivoted into the open position, the first and second connecting elements are loose such that a lower region of the first portion may be moved away from a lower region of the second portion.

9. The sports helmet of claim 8 further comprising grooves or channels provided at the exterior of the second portion of the shell, wherein at least one of the receiving element and the lever is movable along the grooves or channels.

10. The sports helmet of claim 8 wherein the lever is oriented horizontally with respect to the second portion of the shell.

11. A sports helmet, comprising:
a shell including a front portion and a rear portion;
a face guard including an upper section;
a channel in an internal region of the front portion, wherein the upper section of the face guard is secured within the channel.

12. The sports helmet of claim 11 further comprising a cover assembly removably attached to the front portion of the shell, wherein the face guard is attached to the cover assembly.

13. The sports helmet of claim 11 further comprising padding attached to or molded with an interior surface of the front portion of the shell, wherein the channel is located in the padding.

14. The sports helmet of claim 11 further comprising a basket or liner located in the channel, wherein the upper section of the face guard is positioned within the basket or liner.

15. The sports helmet of claim 11 wherein the upper section of the face guard includes a curved portion secured within the channel, wherein the curved portion is removable from the channel when a lower section of the face guard is rotated away from the front portion of the shell.

16. The sports helmet of claim 12 wherein the front portion of the shell includes first and second side portions, and wherein each of the first and second side portions includes an inset region covered by the cover assembly.

17. The sports helmet of claim 16 wherein the face guard includes attachment portions attached to the inset regions and covered by the cover assembly.

18. A method of removing a face guard from a helmet shell, comprising the steps of:
removing connecting elements that secure the face guard to the helmet shell;
rotating a lower section of the face guard away from the helmet shell until an upper section of the face guard disengages from the helmet;
moving the face guard away from the helmet.

19. The method of claim 18 further comprising the step of separating rearmost portions of a cover assembly to which the face guard is attached before the rotating step.

20. The method of claim 18 wherein the removing step comprises removing a plurality of bolts from a cover assembly to which the face guard is attached to free the cover assembly from the helmet shell.
